(19) United States
(12) Patent Application Publication
(10) Pub. No.: US 2017/0147777 A1
(43) Pub. Date: May 25, 2017

(54) METHOD AND APPARATUS FOR PREDICTING HEALTH DATA VALUE THROUGH GENERATION OF HEALTH DATA PATTERN

(71) Applicant: Electronics and Telecommunications Research Institute, Daejeon (KR)

(72) Inventors: YoungWon KIM, Daejeon (KR); Minho KIM, Daejeon (KR); Jae Hun CHOI, Daejeon (KR); Myung-eun LIM, Daejeon (KR); Ho-Youl JUNG, Daejeon (KR); Youngwoong HAN, Daejeon (KR); Dae Hee KIM, Daejeon (KR); Seunghwan KIM, Daejeon (KR)

(21) Appl. No.: 15/353,671

(22) Filed: Nov. 16, 2016

(30) Foreign Application Priority Data
Nov. 25, 2015 (KR) 10-2015-0165486

(51) Int. Cl. G06F 19/00; G06N 5/04; G06N 99/00

(52) U.S. Cl. CPC G06F 19/3431; G06N 99/005; G06N 5/047

(57) ABSTRACT

The inventive concept relates to a method and apparatus for predicting health data values through the generation of a health data pattern. The inventive concept provides a health data value prediction method and apparatus. The health data value prediction method and apparatus may select health data values and important health characteristics associated with the health data values from big data on a plurality of pieces of time-series health information. The health data value prediction method and apparatus may form a health data value prediction model that has repetitively learned the pattern, and accurately predict a user's health data value through the prediction model.

### CROSS-REFERENCE TO RELATED APPLICATIONS

The present application claims priority under 35 U.S.C. §119 of Korean Patent Application No. 10-2015-0165486, filed on Nov. 25, 2015, the entire contents of which are hereby incorporated by reference.

### TECHNICAL FILED

The present disclosure herein relates to a method and apparatus for predicting health data values through the generation of a health data pattern, and more particularly to, a health data value prediction method and apparatus that may select health data values and important health characteristics associated with the health data values from big data on a plurality of pieces of time-series health information, generate a pattern of the health data value based thereon, form a health data value prediction model that has repetitively learned the pattern, and accurately predict a user's health data value through the prediction model.

### DESCRIPTION OF THE RELATED ART

With a rapid development in industrial technology and improvement in people's standard of living, it is a modern trend that the prevalence rate of various diseases, such as chronic disease is considerably increasing due to an increase in harmful factor that threatens people's health, a variation in lifestyle, and bad eating habits.

Especially, the chronic disease is a disease (e.g., diabetes or high blood pressure) that may gently show symptoms, occur slowly for long periods, and lead often to disability, unlike an acute disease (e.g., cold or food poisoning by bacteria) that shows symptoms suddenly for a short time.

Such a chronic disease is a disease that bears high medical costs, and the importance of predicting a patient's physical condition according to continuous monitoring and the progress of the chronic disease to prevent the physical condition from becoming worse and manage health is significantly magnified.

Thus, people's awareness of health increases, health-related big data provided by domestic and foreign big medical institutions or government (e.g., health insurance review & assessment service or national health insurance service) is used to predict user's future physical condition, and various health care services that include medial service or health promotion service suitable for users are being provided by hospitals, oriental medical clinics, or service providers that provide health care service.

Also, in order to appropriately provide the medical service and health promotion service to users, it is most important to accurately predict the progress of the future physical conditions of users who have various diseases including the chronicle disease.

A typical health prediction service system searches for health-related big data provided by the domestic or foreign big medical institutions, through a simple keyword to find health-related big data similar to user's physical condition and predict the user's physical condition based thereon.

A typical health prediction service system simply performs search by using only user's health data value or disease's name. Various information including variations in user's living information and physical information that directly/indirectly affects a corresponding health data value exclude such as major health characteristics according to the user's health data value (e.g., user's age, a variation in weight, body mass index (BMI), total cholesterol, smoking or non-smoking). Thus, prediction information on a physical condition is not being provided with high accuracy.

Together with the development of the state of the art technology, the advancement of a hardware technology, and the development of a data processing technology, a deep network learning technology is rapidly developing.

The deep network learning technology performs a job, i.e., abstraction that summarizes core content or function in a large amount of data or complex data through a combination of many non-linear variation techniques, and in a wide range, it. In other words the deep network learning technology is defined as a machine learning algorithm that attempts to perform an abstraction. The deep network learning technology refers to an artificial intelligence system that is implemented in a computer program to be capable of imitating the mechanism of a nerve cell making up a human being's brain to perform functions similar to human being's brain activities, such as recognition, learning and inference.

Such a deep network learning technology is being applied and utilized in various fields, such as computer vision, voice recognition, natural language processing or signal processing.

Especially, in a medicine field, a technology that uses the deep network learning technology for medical data analysis through pattern analysis has been developed and used, and this technology uses a plurality of patterns (i.e., images) including a radiograph, MRI, a CT image, a microphotograph, or a combination thereof as an input and learns various properties from the input pattern to analyze the property of a disease from input pattern data and diagnose the presence and absence of a disease.

This has an advantage in that it is possible to determine a disease of a type that may not be easily identified with naked eyes, more accurately than people.

However, the current deep network learning technology determines only the presence and absence of a disease through a specific pattern or data. The current deep network learning technology fails to present a method of predicting the progress of the future physical condition of a user based on personal health data that has time-series characteristics.

Thus, the inventive concept generates the pattern of a corresponding specific disease and health characteristic closely related to the health data value using big data including time-series health information. If the user inputs his or her time-series health data, the inventive concept provides the physical condition of a user immediately predicted or to be sequentially predicted later forming a prediction model that has repetitively learned the pattern. The inventive concept provides a health data value prediction method and apparatus. The apparatus is possible to provide useful information or alarm to enable the user to systematically perform health care according to the predicted physical condition or to use appropriate health promotion service or medical service based on the predicted physical condition.

Next, a related art in the technical field of the inventive concept is briefly described, and subsequently, technical matters that the inventive concept is distinguished from the related art are stated.

First, Korea Patent No. 673252 (issued on Jan. 22, 2007) relates to a “SYSTEM FOR HEALTH PREDICTING USING MOBILE AND METHOD FOR PROVIDING CONTENTS HAVING HEALTH PREDICTING INFORMATION”, and more particularly to a “SYSTEM FOR HEALTH PREDICTING USING MOBILE AND METHOD FOR PROVIDING CONTENTS HAVING HEALTH PREDICTING INFORMATION” that provide users with symptom information and occurrence prediction information on various diseases based on health information on users anytime and anywhere without constraints on places and time through a personal mobile connected to a wired/wireless communication network including a mobile communication network and the internet network and a health prediction server for providing health prediction information according to a user.

The related art is partially similar to the inventive concept in that user's health is predicted based on health information on users. However, the inventive concept previously forms a prediction model to predict a variation in future health data value of a user through the prediction model without searching for symptom information according to a disease based on health information according to the user as in the related art. The related art does not describe or suggest a technical characteristic that assumes a known health data value as an identifiable value or wrong value due to damage on the premise that a future health data value is already known, and recovers an accurate value to predict the future health data value of a user.

Also, Korea Patent No. 434823 (issued on May 27, 2004) relates to a patient's physical condition monitoring method that measures. Korea Patent No. 434823 (issued on May 27, 2004) related to predict the blood sugar level of a patient's blood sample, and more particularly to, a patient's physical condition monitoring method that measures and predicts the blood sugar level of a patient's blood sample, which may track and predict the progress of a blood sugar level through a mathematical model to which a specific equation related to the progress of the blood sugar level of a patient is applied.

The related art is partially similar to the inventive concept in that the progress of a corresponding health data value is tracked and predicted by the using of a specific health data value, patient's personal health data. However, the related art does not describe or suggest a technical characteristic according to the inventive concept that periodically collects big data on time-series health information to extract major health data values related to a specific disease and health characteristics associated with the major health data values from the collected big data. Also, the inventive concept predicts the progress of the future physical conditional of the user through a prediction model that is learned and verified based on the time-series pattern of the extracted data.

### SUMMARY

The present disclosure provides a health data value prediction method and apparatus. The health data value prediction method and apparatus may form a prediction model capable of predicting the progress of a physical condition according to a health data value according to big data based on the big data on time-series health information provided by public institutions and big medical institutions, and accurately predict the future physical condition of a user through the formed prediction model so that the user may use reliable medical service or health promotion service based on the predicted physical condition.

In some example embodiments, a method of predicting a health data value of an apparatus generalizes of a health data pattern. The method comprises performing learning of a prediction model for a health data value by using a pattern of a plurality of pieces of health data and generating a prediction model by verifying performance of the prediction model by determining a prediction model. The prediction model is learned to output a generalized prediction result of health data.

In some example embodiments, the method further comprises selecting a health data value and health characteristic related to a specific disease from the health data and normalizing the selected health data value and the selected health characteristic.

In some example embodiments, the method further comprises dividing the normalized health data into a training data group and a verification data group, and generating a pattern from the normalized health data of the divided training data group and the verification data group.

In some example embodiments, the performing of the learning of the prediction model comprises performing the learning of the generated prediction model by using the training data group, and verifying performance of the learned prediction model by using the verification data group.

In some example embodiments, the method further comprises performing preprocessing that comprises selecting a health data value and health characteristic related to a specific disease from user's personal health data, and normalizing the selected health data value and health characteristic, generating a pattern from the normalized personal health data; and applying a prediction model to the generated pattern to extract a result of prediction on the user's health data value.

In some example embodiments, the prediction model is generated by applying of a machine learning technique that comprises deep network learning, machine learning, support vector machine (SVM), a neural network or the like.

In some example embodiments, the prediction model predicts a future health data value from past time-series personal health data, wherein the future health data value is predicted by recovering of a damaged portion of the past time-series health data.

In some example embodiments, an apparatus predicts a health data value through generalization of a health data pattern. The apparatus comprises a prediction model learning unit configured to perform learning of a prediction model for a health data value by using a pattern of a plurality of pieces of health data, and a prediction model generation unit configured to generate the prediction model by verifying the prediction model to determining performance of the prediction model. The prediction model is learned to output a generalized prediction result of health data.

In some example embodiments, the apparatus further comprises a first preprocessing unit configured to select a health data value and health characteristic related to a specific disease from the health data. The first preprocessing unit configured to normalize the selected health data value and health characteristic.

In some example embodiments, the apparatus further comprises a training/verification data selection unit configured to divide the normalized health data into a training data group and a verification data group. A first pattern generating unit is configured to generate a pattern from the health data of the training data group and the verification data group.

In some example embodiments, the prediction model learning unit is configured to perform the learning of the generated prediction model by using the training data group. The prediction model generation unit is configured to verify performance of the learned prediction model by using the verification data group.

In some example embodiments, the apparatus further comprises a second preprocessing unit, a second pattern generation unit and a health data value prediction unit. The second preprocessing unit is configured to select a health data value and health characteristic related to a specific disease from user's personal health data. The second preprocessing unit is configured to normalize the selected health data value and health characteristic. The second pattern generation unit is configured to generate a pattern from the normalized personal health data. The health data value prediction unit is configured extract a result of prediction on the user's health data value by applying a prediction model to the generated pattern.

In some example embodiments, the prediction model is generated by applying of a machine learning technique that comprises deep network learning, machine learning, support vector machine (SVM), a neural network or the like.

In some example embodiments, the prediction model predicts a future health data value from past time-series personal health data, wherein the future health data value is predicted by recovering of a damaged portion of the past time-series health data.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a conceptual view for explaining a health data value prediction method and apparatus through the generalization of a health data pattern according to an example embodiment;

FIG. 2 is a block diagram of a health data value prediction apparatus through the generalization of a health data pattern according to an example embodiment;

FIG. 3 is a flow chart that represents procedures of forming a prediction model and predicting the future physical condition of a user based on user's personal health data according to an example embodiment;

FIGS. 4A and 4B image the pattern of a user's health data value based on user's personal health data according to an example embodiment;

FIGS. 5A and 5B image the pattern of a specific health data value based on medical big data according to an example embodiment;

FIG. 6 illustrates how to input a pattern image through a prediction model, learn the prediction model and predict through the prediction model according to an example embodiment;

FIG. 7 illustrates how to predict a health data value, in a health data value prediction method and apparatus through the generalization of a health data pattern according to an example embodiment.

### DETAILED DESCRIPTION

In the following, exemplary embodiments of the inventive concept are described in detail with reference to the accompanying drawings. Like reference numerals in the drawings refer to like members.

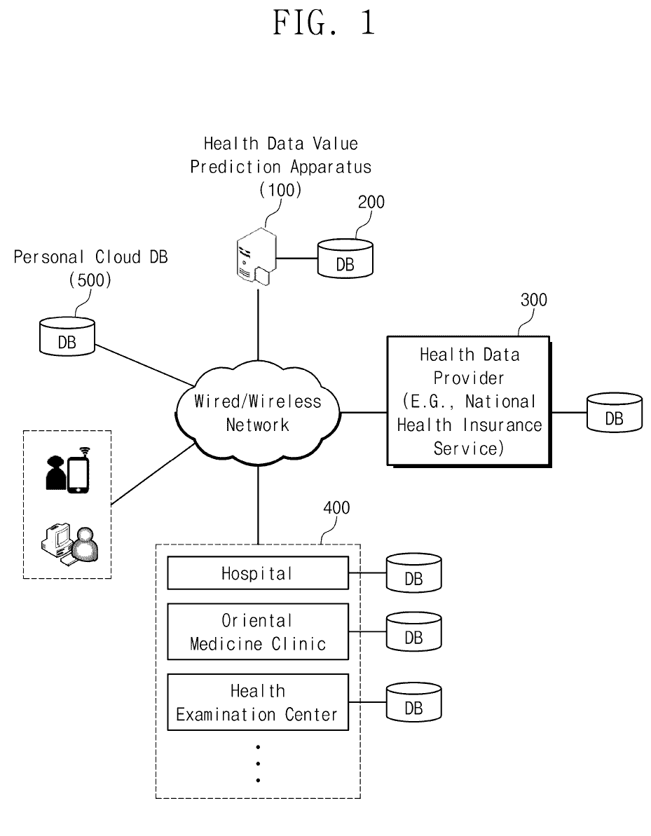

FIG. 1 is a conceptual view for explaining a health data value prediction method and apparatus through the generalization of a health data pattern according to an example embodiment.

First, a typical user's physical condition prediction system predicts a user's physical condition based on only already well-known general medical information without considering physical or health characteristics closely associated with the user's physical condition.

However, it is true that the health characteristics significantly affect a corresponding health data value, thus in predicting the user's physical condition, not only the health characteristics but also the health data value are significantly important.

For example, in the case where hypertensive patients A (smoker and non-vegetarian) and B (non-smoker and vegetarian) who show a significantly similar aspect in blood pressure value measured for a certain period want information on blood pressure values predicted for future three months. The above-described existing prediction systems will predict the same blood pressure value and provide it to the hypertensive patients A and B. However, since the hypertensive patient B is a non-smoker and vegetarian, it is obvious that the hypertensive patients A and B shows a blood pressure value having another aspect (The hypertensive patient B would be closer to a normal blood pressure in comparison to the hypertensive patient A).

That is, when the user's physical condition is predicted with only a specific health data value, it is difficult to accurately predict a physical condition according to a user. There is a limitation that causes unnecessary expense, because the user may use wrong medical service or health promotion service.

Thus, the inventive concept forms prediction model so that the user may use systematic care on the predicted physical condition and reliable health promotion service and medical service based on major health data values and important health characteristics. The major health data values in a plurality of pieces of time-series health data may be periodically collected. The inventive concept provides a health data value prediction method and apparatus. And the health data value prediction method and apparatus may form a prediction model capable of accurately predicting the physical condition by providing future health data value of a user through the formed prediction model.

As shown in FIG. 1, a user receives the personal health data from the health data provider 300 or 400 by requesting user's personal health data from a health data provider 300 or 400.

The health data provider 300 or 400 may exist in various forms, such as a hospital or oriental medicine clinic that diagnoses a user's disease or health examination center that periodically examines user's health.

Also, the personal health data is time-series data and refers to one or more pieces of accumulated health data value (e.g., blood sugar value, blood pressure value, cholesterol value, height or weight) data in a health column, such as a health information column in the personal health data. Also, the health data value may be different in accumulated time interval.

For example, health examination data that the health examination center issues may be generally accumulated at a long time interval, such as once or twice per one year. That is, person A's health examination data may be written in March 2008, March 2009, March 2011, and March 2012.

Also, the health data value in the personal health data may also be accumulated at a long time interval as described in the health examination data above. However, health data values (e.g., weight, blood pressure or diabetes) may be recorded every day. In addition, it would be also possible to collect the health data value every second or at a shorter interval by a health information measuring sensor that has been attached to the body. As such, the personal health data may include various forms.

Also, the user may store the personal health data received from the health data provider 300 or 400 in a storage of a user terminal or in a personal cloud DB 500 over the internet. The personal health data is used as data for predicting the user's health data value by the health data value prediction apparatus 100.

Also, the health data value prediction apparatus 100 forms at least one prediction model in order to predict the user's health data value from health data based on the user's personal health data.

The health data is big data that includes time-series health information, patients' diagnosis data, and medical data. The time-series health information is periodically collected from the health data provider 300 or 400. The patients' diagnosis data is stored in domestic and foreign big hospitals. The medical data is received from national health insurance service or health insurance review & assessment service. The health data is collected by a person through a health information measuring sensor. And the health data means big data on millions or hundreds of millions of time-series health information stored in a storage of each of the health data providers 300 and 400.

Also, the health data may be collected directly by the health data value prediction apparatus 100. Alternatively, the health data may periodically receive from a system providing a medical service or health promotion service to the user in conjunction with the health data value prediction apparatus 100.

That is, the health data value prediction apparatus 100 is implemented in conjunction with the service system or independently.

Also, the health data value prediction apparatus 100 extracts a major health data value related to each specific disease and health characteristics. The health characteristics are associated with the major health data value from the plurality of pieces of health data in order to form a prediction model for predicting the user's physical condition through a pre-processing process.

Also, for the extraction, the health data value prediction apparatus 100 may previously store a mapping table in which a health data value is mapped to health characteristics associated with the health data value.

For example, in the case where one of health data value prediction models is a prediction model predicting a blood sugar value, the health data value prediction apparatus 100 extracts the blood sugar value with reference to the mapping table and extracts health characteristics (e.g., age, sex, BMI, total cholesterol value, and smoking or non-smoking). The health characteristics are associated with the blood sugar value mapped to the blood sugar value. The health data value prediction models are a prediction model is formed through the health data value prediction apparatus 100.

Also, the pre-processing process normalizes the extracted health data value and data on the health characteristics in order to apply them to the prediction model.

That is, the health data value prediction apparatus 100 aligns the blood sugar value from a minimum value to a maximum value. The blood sugar value is selected from the health data. Then, the health data value prediction apparatus 100 converts the blood sugar value and health characteristic values into values between 0 and 1. The minimum value is 0, the maximum value is 1, and intermediate value is 0.5.

Also, in the case of the health characteristic (e.g., smoking or non-smoking) which is not represented by a specific value, smoking may be converted into 1 and non-smoking may be converted into 0.

Also, the health data value prediction apparatus 100 randomly divides the normalized health data into a training data group and a verification data group in order to generate the prediction model through the learning.

Also, the training data group is a health data group that is used for generating the health data value prediction model through the learning of the prediction model. The verification data group is a health data group that is used for verifying the performance of the generated prediction model.

Also, the verification data does not participate in the learning of the prediction model.

The health data value prediction apparatus 100 applies machine learning techniques (e.g., deep network learning, machine learning, support vector machine (SVM), and neural network) in order to generate the prediction model through the training data group. Since the inventive concept is not limitative applied to these techniques, the learning techniques have no limitation.

Also, the health data value prediction apparatus 100 generates a pattern of the health data value based on the converted health data value and health characteristics. The health data value prediction apparatus 100 trains the prediction model by using the generated pattern. That is, the training data and the verification data are generated as patterns.

The pattern of the health data value may be represented by a value or graph based on a specific value (e.g., binary or hexadecimal number). Also, the pattern of the health data value is not limited to only the above-described imaging. That is, all methods capable of representing the pattern of the health data value are possible and there is no limitation in method.

Also, the health data value prediction apparatus 100 generates at least one prediction model based on the imaged training data. That is, the extracted health data value may be not only blood sugar but also blood pressure as described in the example above and in addition. It is also possible to select a major health data value or combine several major health data values. Thus, the health data value prediction apparatus 100 may generate various prediction models according to the extracted health data value.

Also, the health data value prediction apparatus 100 that has generated the prediction model verifies the performance of the prediction model that has performed the learning by using the verification data group. The health data value prediction apparatus 100 generates a finally learned prediction model according to a result of the verification. And the generated prediction model is stored in the DB 200.

Also, the health data value prediction apparatus 100 trains the prediction model based on the training data group. The health data value prediction apparatus 100 trains the prediction model to output an accurate prediction value by adjusting the weight value of the prediction model. The health data value prediction apparatus 100 uses a prediction value output through the prediction model as an output value of the training data.

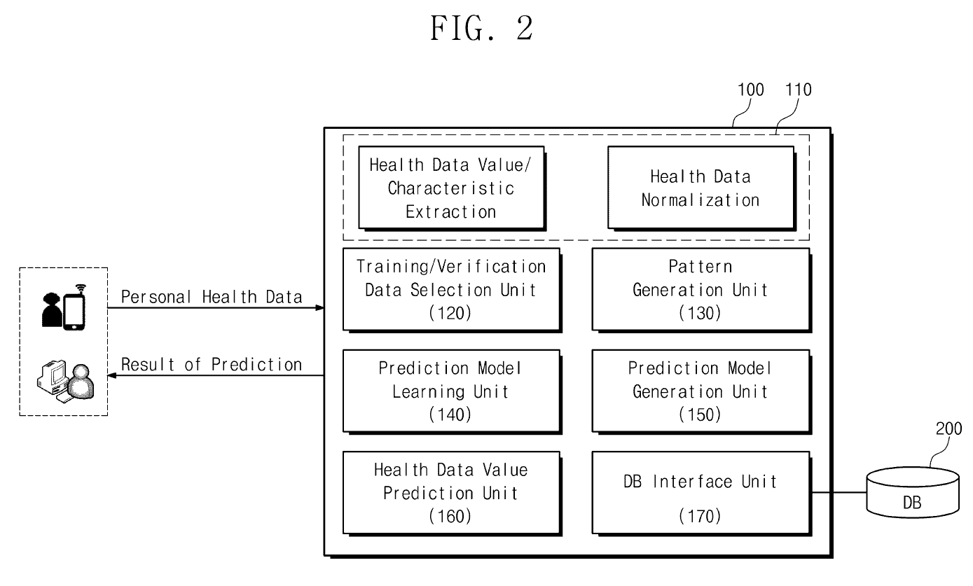

FIG. 2 is a block diagram of a health data value prediction apparatus through the generalization of a health data pattern according to an example embodiment.

As shown in FIG. 2, the health data value prediction apparatus 100 includes a pre-processing unit 110, a training/verification data selection unit 120, a pattern generation unit 130, a prediction model learning unit 140, a prediction model generation unit 150, a health data value prediction unit 160, and a DB interface unit 170. The pre-processing unit 110 normalizes health data and user's personal health data. The training/verification data selection unit 120 divides the health data pre-processed through the pre-processing unit 110 into a training data group and a verification data group. The pattern generation unit 130 generates a pattern according to a specific health data value from the personal health data pre-processed through the pre-processing unit 110, the training data group or the verification data group. The prediction model learning unit 140 learns a prediction model based on the generated pattern. The prediction model generation unit 150 verifies the performance of the generated prediction model to generate the prediction model. The health data value prediction unit 160 uses a pattern of the personal health data and the generated prediction model to predict a user's physical condition. The DB interface unit 170 loads data from a DB 200 or stores data in the DB 200.

The term “unit” may include hardware and/or a special purpose computer programmed to perform the functions of the “unit.” Therefore, the pre-processing unit 110, the training/verification data selection unit 120, the pattern generation unit 130, the prediction model learning unit 140, the prediction model generation unit 150, and the health data value prediction unit 160 and may be hardware, firmware, hardware executing software or any combination thereof. When at least one of the pre-processing unit 110, the training/verification data selection unit 120, the pattern generation unit 130, the prediction model learning unit 140, the prediction model generation unit 150, and the health data value prediction unit 160 is hardware, such existing hardware may include one or more Central Processing Units (CPUs), digital signal processors (DSPs), application-specific-integrated-circuits (ASICs), field programmable gate arrays (FPGAs) computers or the like configured as special purpose machines to perform the functions of the at least one of the pre-processing unit 110, the training/verification data selection unit 120, the pattern generation unit 130, the prediction model learning unit 140, the prediction model generation unit 150, and the health data value prediction unit 160. CPUs, DSPs, ASICs and FPGAs may generally be referred to as processors and/or microprocessors.

In the event where at least one of the pre-processing unit 110, the training/verification data selection unit 120, the pattern generation unit 130, the prediction model learning unit 140, the prediction model generation unit 150, and the health data value prediction unit 160 is a processor executing software, the processor is configured as a special purpose machine to execute the software, stored in a storage medium, to perform the functions of the at least one of the pre-processing unit 110, the training/verification data selection unit 120, the pattern generation unit 130, the prediction model learning unit 140, the prediction model generation unit 150, and the health data value prediction unit 160. In such an example embodiment, the processor may include one or more Central Processing Units (CPUs), digital signal processors (DSPs), application-specific-integrated-circuits (ASICs), field programmable gate arrays (FPGAs) computers.

Also, the pre-processing unit 110 extracts at least one health characteristics and major health data value. The health characteristics are related to health data value. The major health data value is associated with a specific disease the health data value from the input user's personal health data and a plurality of health data.

The pre-processing unit 110 may extract a health data value (e.g., blood pressure value or blood sugar value) from the user's personal health data or the health data with reference to a mapping table The pre-processing unit 110 may extract health characteristics mapped to the selected health data value.

The reason is not to predict the user's physical condition based on only the health data value but to accurately predict the user's physical condition in consideration of user's physical information (e.g., height, weight or degree of obesity) affecting or affected by the health data value or living habit (e.g., smoking or non-smoking, or eating habit, such as vegetarianism) information.

Also, the pre-processing unit 100 normalizes the extracted health data value and a plurality of corresponding health characteristics to be suitable for the prediction model.

The normalization refers to converting the extracted health data value and the plurality of health characteristics to values between 0 and 1.

Also, the health data value that is selected from the personal health data or the plurality of pieces of health data by the pre-processing unit 110. The health data value may be in singularity or in plurality.

The pre-processing unit 100 may include a first pre-processing unit and a second pre-processing unit. The first pre-processing unit extracts a health data value and health characteristic related to a specific disease from the health data. The first pre-processing unit normalizes the selected health data value and health characteristic. The second pre-processing unit extracts a health data value and health characteristic related to a specific disease from the user's personal health data. The second pre-processing unit normalizes the selected health data value and health characteristic.

Also, the training/verification data selection unit 120 is divided to a training data group and a verification data group. The training data group randomly generates plurality of health data that pre-processed through the pre-processing unit 110. And the verification data group verifies the performance of the prediction model.

Also, the training data group is used for the repetitive learning of the generated prediction model. The verification data model is used for verifying the performance of the prediction model learned by using the training data group.

Also, the pattern generation unit 130 generates bin (pixel of an image) with respect to patterns of major health data values of the user's personal health data pre-processed, the training data group and the verification data group and then generates n×m binary images.

For example, the blood pressure value (e.g., major health data) and the health characteristic related to the blood pressure value are selected from the user's personal health data, the training data group, or the verification data group. A range of the blood pressure value is divided into n sections. The bin is generated with respect to m blood pressure values that represent each section. And then the bin is converted into an image so that there are n×m binary images.

The pattern generation unit 130 may generate the pattern through various methods by which it is possible to represent the pattern as described above as well as generating the pattern.

The pattern generation unit 130 may include a first pattern generation unit and second pattern generation unit. The first pattern generation unit generates a pattern of the health data. The second pattern generation unit generates a pattern of the user's personal health data.

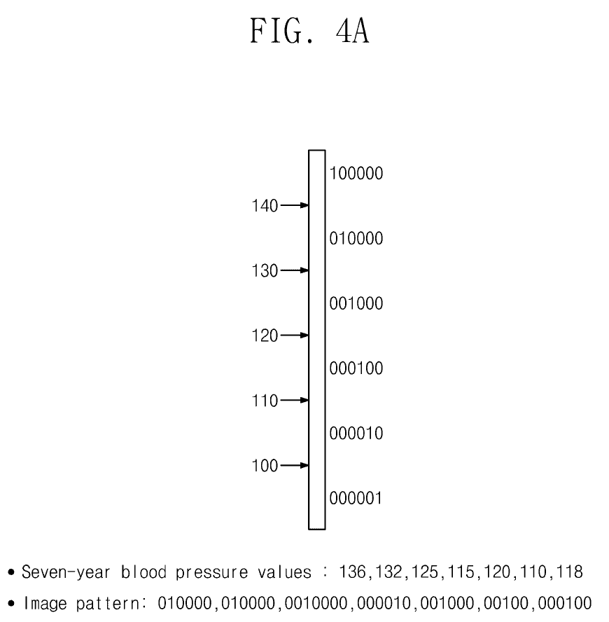

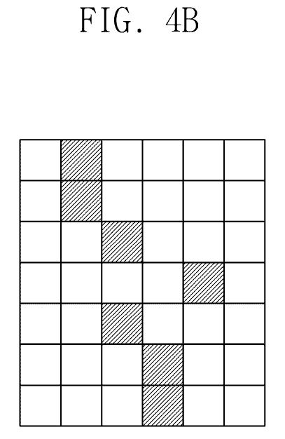

The pattern of the health data value as described above is described in detail with reference to FIG. 4.

Also, the prediction model learning unit 140 uses the training data group to generate the prediction model and perform the learning thereof.

Also, the prediction model learning unit 140 learns the prediction model to determine an image pattern of the training data group from the training data group.

For example, when it is assumed that the training data group is a pattern of seven years' blood pressure values, the seventh year's blood pressure value is obtained as the output value of the prediction model. Learning is performed to predict the seventh year's blood pressure value as the output value by using a pattern of six years' blood pressure values. That is, the prediction model is performed learning so that an already pattern of blood pressure values is accurately predicted by applying the already known pattern of blood pressure value to the prediction model.

Also, learning through the prediction model learning unit 140 is performed by using all pieces of training data included in the training data group.

Also, the prediction model generation unit 150 performs the function of verifying the performance of the health data value prediction model by using the verification data group. The health data value prediction model is learned through the prediction model learning unit 140. Also, the verification is performed in the same mechanism as the above-described learning process.

Also, when a result of the verification exceeds a critical value preset by a user, the prediction model generation unit 150 may generate a corresponding prediction model. Then, the generated prediction model is stored in DB 200. When a request for prediction on a physical condition receives from the user, the prediction model generation unit 150 may provide a result of the prediction by using the stored prediction model.

In the case where the performance of the prediction model does not exceed the critical value through the verification. The prediction model learning unit 140 repetitively performs the learning of the prediction model by using the training data group.

Also, the prediction unit 160 predicts the user's physical condition by applying the personal health data input by the user to the prediction model in the case where there is a request for prediction on the user's physical condition.

Also, the DB 200 stores the prediction model, health data, the pattern of the health data, the mapping table or the like.

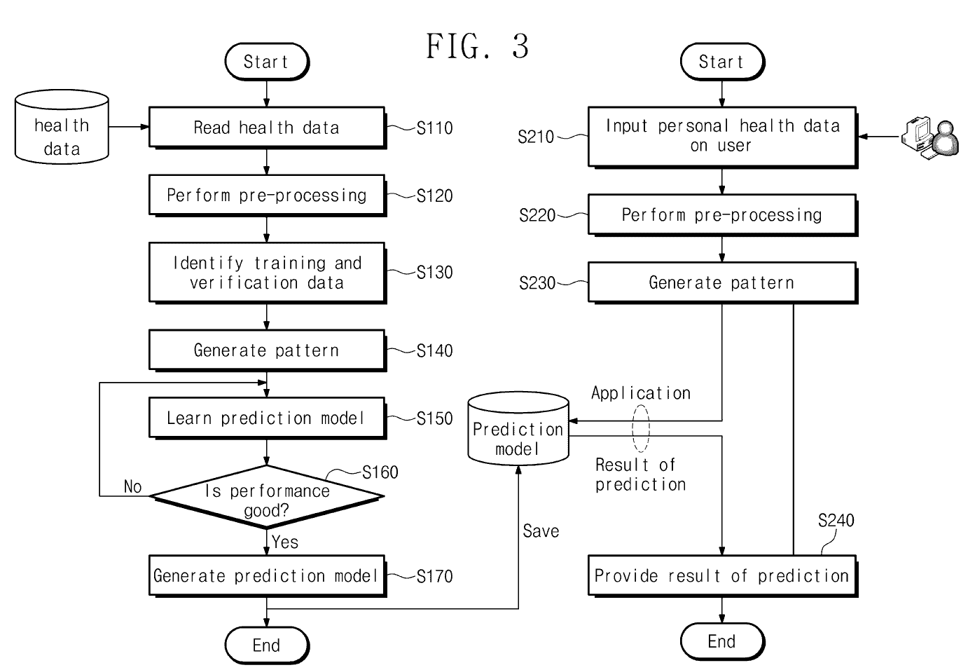

FIG. 3 is a flow chart that represents procedures of forming a prediction model and predicting user's future physical condition based on user's personal health data according to an example embodiment.

As shown in FIG. 3, the health data value prediction apparatus 100 periodically receives health data from the health data provider 300 or 400, for predicting the user's future physical condition in step S110.

Next, the health data value prediction apparatus 100 performs pre-processing on the health data. Then, the health data value prediction apparatus 100 extracts a major health data value and health characteristics associated with the major health data value. The health data value prediction apparatus 100 normalizes the extracted health data value and health characteristics in step S120.

Next, the health data value prediction apparatus 100 verifies a training data group and the performance of the prediction model. The training data group may learn normalized health data into the prediction model. The health data value prediction apparatus 100 divides a verification data group for verifying the performance of the prediction model and generating the prediction model in step S130.

Next, the health data value prediction apparatus 100 generates a pattern of the extracted health data value from the training data group and the verification data group in step S140.

Next, the health data value prediction apparatus 100 performs the learning of the prediction model by using the training data group of the pattern of the health data value in step S150.

Next, the health data value prediction apparatus 100 performs the performance of the learned prediction model by using the verification data group. The health data value prediction apparatus 100 generates a prediction model by determining a finally learned prediction model and stores in the DB in step S170 in the case where as a result of the verification, the preset specific critical value is exceeded in step S160.

In the case where as a result of the verification, the critical value is not exceeded, the health data value prediction apparatus 100 repetitively performs the learning of the prediction model by using the training data group. The prediction model may output an accurate prediction result, through the repetition of the learning and verification.

Also, in the case where personal health data is input from the user in step S210, the health data prediction apparatus 100 performs the same processing process on the user's personal health data as the health data has been pre-processed, in step S220.

That is, the health data prediction apparatus 100 selects a major health data value and health characters associated with the major health data value from the user's personal health data. The health data prediction apparatus 100 normalizes data for the selected major health data value and the health characters to applying the prediction model.

Next, the health data prediction apparatus 100 generates a pattern of the major health data value based on the normalized data on the health data value and health characteristics in step S230.

Next, the health data value prediction apparatus 100 provide a result of prediction to the user by applying the pattern to the health data value prediction model in step S240.

FIGS. 4A and 4B image the pattern of a user's health data value based on user's personal health data according to an example embodiment.

As shown in FIGS. 4A and 4B, the health data value prediction apparatus 100 selects and images a major health data value and health characteristics from time-series health data. The time-series health data includes health data or user's personal health data. FIGS. 4A and 4B are image an example of selecting and imaging a blood pressure value as the major health data value.

Also, the health data value prediction apparatus 100 firstly generates bin as shown in FIG. 4A in order to generate a pattern image of the selected blood pressure value.

As shown in FIG. 4A, the health data value prediction apparatus 100 divides the blood pressure value into six sections and generates bin that represents the six sections.

Also, the user's blood pressure value is set to one of the six bins, and the sections of the blood pressure value shown in FIG. 4A include 140<=blood pressure value, 140<blood pressure value<=130, 130<blood pressure value<=120, 120<blood pressure value<=110, 110<blood pressure value<=100, and 100>blood pressure value.

The bin represents the section of the blood pressure value by a binary number. Also, when the health value prediction apparatus 100 converts the bin and seven years' blood pressure value into an image, there are 6×7 binary images as shown in FIG. 4B The bin in the image is represented by a pattern of the seven years' blood pressure value.

It has been described above that the pattern may be represented by a graph or specific value as well as an image.

Also, the health data value prediction apparatus 100 generates, learns and verifies the prediction model. The health data value prediction apparatus 100 predicts the user's physical condition by using the image.

When the prediction model is input to the health data value prediction apparatus 100 without the health data value (e.g., blood pressure value) and a plurality of health characteristics, the prediction model should perform prediction by calculating both the selected health data value and the plurality of health characteristics. The health data value is related to a specific disease. And the plurality of health characteristics is associated with the health data value. However, the inventive concept has simplified calculation to be performed for prediction on the physical condition by the prediction model by generating an image based on the health data value and the health characteristics and using only the generated image as the input of the prediction model.

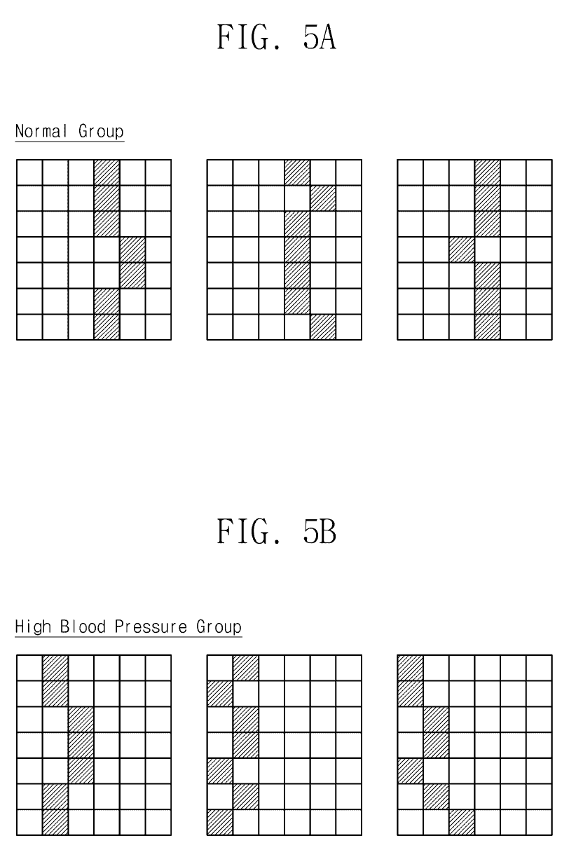

FIGS. 5A and 5B image the pattern of a specific health data value based on medical big data according to an example embodiment.

FIG. 5A shows blood pressure value patterns of persons who have a normal blood pressure value. FIG. 5B shows blood pressure value patterns of persons who have high blood pressure.

As shown in FIGS. 5A and 5B, there are various patterns of blood pressure value in a normal group or high blood pressure group. Thus, the health data value prediction apparatus 100 receives a large amount of health data from the health data provider 300. The health data value prediction apparatus 100 repetitively performs the learning of a prediction model through the pattern image by imaging the health data value pattern based on each health data value and health characteristics associated with the health data value. The health data value prediction apparatus 100 simplifies calculation for prediction on the health data value. And the health data value prediction apparatus 100 provides an accurate reliable prediction result to a user.

Also, a pattern in the pattern image has a characteristic in that it is formed by information on the health data value. The plurality of health characteristics, associated with the health data value, is extracted by the health data value prediction apparatus 100. This has an advantaged in that it is possible to output a result of prediction based on the health data value. The plurality of health characteristics not input the health data value and the plurality of health characteristics one by one to the prediction model for prediction on the health data value but by inputting only the pattern image.

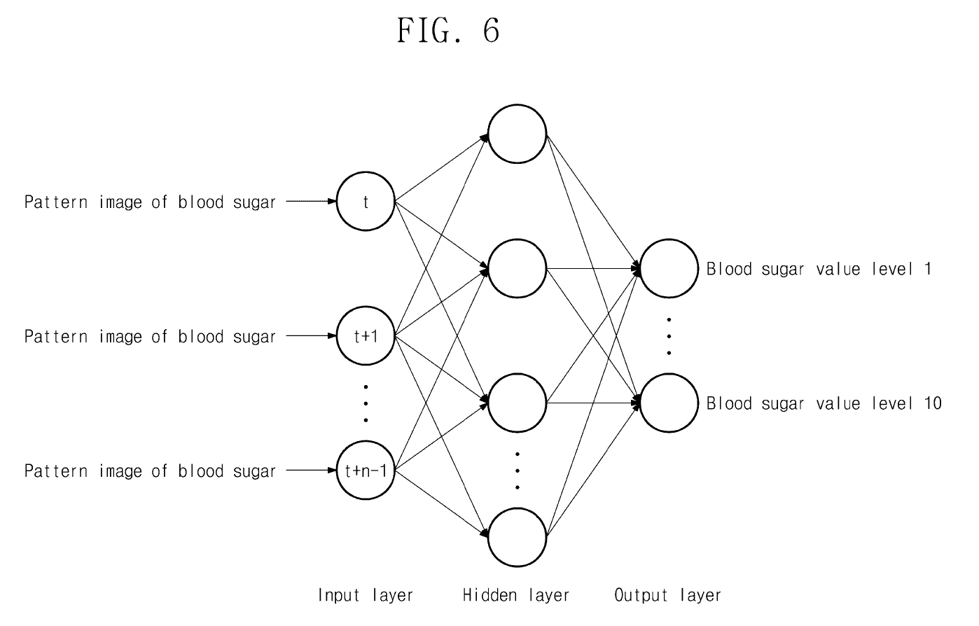

FIG. 6 illustrates how to input a pattern image through a prediction model, learn the prediction model and predict according to an example embodiment.

As shown in FIG. 6, the prediction model formed by the health data value prediction apparatus 100 includes an input layer, a hidden layer and an output layer.

Also, the input layer includes a plurality of input modes. The hidden layer includes a plurality of hidden nodes. The output layer includes a plurality of output nodes.

In describing the prediction model in detail with reference to FIG. 6, a blood sugar value prediction model that performs prediction on a blood sugar value is described as an example in detail.

Also, data input to the input layer of the blood sugar value prediction model is time-series health data. The time-series health data is data obtained by imaging the blood sugar value pattern based on the blood sugar value and health characteristics. The blood sugar value is selected by the health data value prediction apparatus 100. And the health characteristics are associated with the blood sugar value.

Also, the output of the blood sugar value prediction model includes an output layer that includes ten learned output nodes, and an output node having the highest probability value selected by the input pattern image means the prediction value of the blood sugar value.

Also, each output node of the blood sugar value prediction model has a level of the blood sugar value. The level of the blood sugar value includes ten levels. The section of the blood sugar value per level may be designed to have a size of 10. For example, level 1 is smaller or equal to 57 in blood sugar value, level 2 is greater than 57 and smaller than or equal to 66 in blood sugar value, and level 3 is greater than 67 and smaller than equal to 76 in blood sugar value.

Also, the level of the output node is set to a desired label value of each piece of training data that makes up the training data group.

For example, when the year n's blood sugar value of a piece of training data is 60, the training data is labeled to 2 and the prediction model is learned as a group of ‘2’. That is, the prediction model uses the year n's blood sugar value ‘60’ of training data as a prediction value. The prediction model uses data until year n−1 of training data (pattern image) as an input to perform learning.

Also, the health data value prediction apparatus 100 performs training according to a deep network learning mechanism by inputting a large amount of training data groups to the blood sugar value prediction model. The health data value prediction apparatus 100 finds a unique property according to the blood sugar value level in a flow of training data in year n−1 to adjust the weight between the input node, the hidden node, and the output node. The information may be output as the desired label value of the pieces of training data.

It is reasonable that the health data value prediction apparatus 100 is not limited to the deep network learning and may apply various machine learning techniques, such as machine learning, support vector machine (SVM), and neural network.

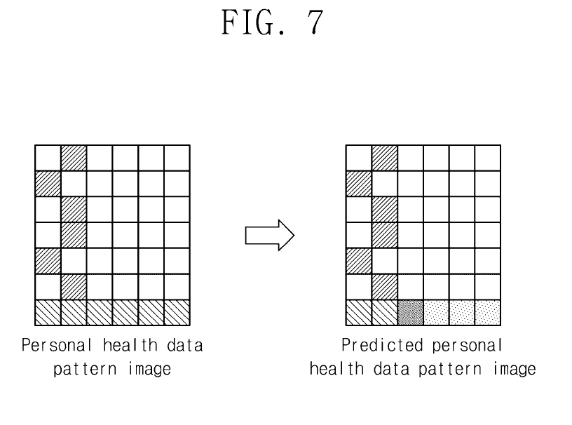

FIG. 7 illustrates how to predict a health data value, in a health data value prediction method and apparatus through the generalization of a health data pattern according to an example embodiment.

As shown in FIG. 7, the prediction model is learned by a pattern image of a specific health data value of a plurality of pieces of health data. If user's personal health data pattern image similar to the learned image is input, the prediction model is predicted by outputting a similar pattern that most frequently learned a progress of the specific health value.

That is, the prediction model is learned to output the generalized prediction result of health data from a pattern of a plurality of pieces of health data. The prediction model predicts and provides the user's future health data value based thereon.

Also, the prediction model recovers a pattern image of the input user's personal health data to provide a result of prediction.

For example, when a pattern image is input in order to predict a user's health data value at a time of eight or longer years, the prediction model considers that a pattern is not recognized. A part of the pattern image is damaged or includes noise. The part of the pattern image represents a time of the eight or longer years. For example, The pattern image is based on user's personal health data representing seven years' time-series health information.

In addition, the prediction model recovers the part of the pattern image considered as the damage or pattern recognition failure at a time of eight or longer years by using a pattern similar or equal to the image learned through a large amount of health data. In this way, prediction information (e.g., a health data value at a time of eight or longer years) is provided to the user.

That is, when the prediction model predicts the future health data value from the past time-series user's personal health data. The future health data value is predicted by the recovering of a damaged portion of the past time-series health data. An accuracy of prediction value increases with an increase of health data.

As described above, the health data value prediction method and apparatus of the inventive concept may image a pattern of a health data value based on important health characteristics. The important health characteristics are associated with the health data value in a plurality of pieces of time-series medical big data. The health data value prediction method and apparatus of the inventive concept may form a prediction model by repetitively learning the image. The health data value prediction method and apparatus of the inventive concept accurately predict the progress of the user's future physical condition through the formed prediction model to provide reliable prediction information.

The inventive concept relates to a health data value prediction method and apparatus through the generalization of a health data pattern. The inventive concept has an effect in that it is possible to use big data on a plurality of time-series health information to predict the user's future health data value through the repetitively learned and verified prediction model to allow the user to systematically perform health care according to a variation in predicted health data value and use a reliable medical service and health promotion service.

Although exemplary embodiments according to the inventive concept have mostly been above, the technical spirit of the inventive concept is not limited thereto. The inventive concept may be changed or modified within the technical scope of the inventive concept in order to achieve the same object and effect.

Also, although exemplary embodiments of the inventive concept have been shown and described above, the inventive concept is not limited the above-described specific embodiments, many variations may be implemented by a person skilled in the art to which the inventive concept pertains, without departing from the subject of the inventive concept claimed in the claims, and such variations should not be understood separately from the technical spirit and prospect of the inventive concept.

What is claimed is:

1. A method of predicting a health data value of an apparatus through generalization of a health data pattern, the method comprising:
performing learning of a prediction model for a health data value by using a pattern of a plurality of pieces of health data; and
generating a prediction model by verifying performance of the prediction model by determining a prediction model and,
wherein the prediction model is learned to output a generalized prediction result of health data.

2. The method of claim 1, further comprising:
selecting a health data value and health characteristic related to a specific disease from the health data and normalizing the selected health data value and the selected health characteristic.

3. The method of claim 2, further comprising:
dividing the normalized health data into a training data group and a verification data group; and
generating a pattern from the normalized health data of the divided training data group and the verification data group.

4. The method of claim 3, wherein the performing of the learning of the prediction model comprises:
performing the learning of the generated prediction model by using the training data group; and
verifying performance of the learned prediction model by using the verification data group.

5. The method of claim 1, further comprising:
performing preprocessing that comprises selecting a health data value and health characteristic related to a specific disease from user's personal health data, and normalizing the selected health data value and health characteristic;
generating a pattern from the normalized personal health data; and
applying a prediction model to the generated pattern to extract a result of prediction on the user's health data value.

6. The method of claim 1, wherein the prediction model is generated by applying of a machine learning technique that comprises deep network learning, machine learning, support vector machine (SVM), a neural network or the like.

7. The method of claim 1, wherein the prediction model predicts a future health data value from past time-series personal health data, wherein the future health data value is predicted by recovering of a damaged portion of the past time-series health data.

8. An apparatus for predicting a health data value through generalization of a health data pattern, the apparatus comprising:
a prediction model learning unit configured to perform learning of a prediction model for a health data value by using a pattern of a plurality of pieces of health data; and
a prediction model generation unit configured to generate the prediction model by verifying the prediction model to determining performance of the prediction model,
wherein the prediction model is learned to output a generalized prediction result of health data.

9. The apparatus of claim 8, further comprising:
a first preprocessing unit configured to select a health data value and health characteristic related to a specific disease from the health data and normalize the selected health data value and health characteristic.

10. The apparatus of claim 9, further comprising:
a training/verification data selection unit configured to divide the normalized health data into a training data group and a verification data group; and
a first pattern generating unit configured to generate a pattern from the health data of the training data group and the verification data group.

11. The apparatus of claim 10, wherein the prediction model learning unit configured perform the learning of the generated prediction model by using the training data group, and
the prediction model generation unit configured to verify performance of the learned prediction model by using the verification data group.

12. The apparatus of claim 8, further comprising:
a second preprocessing unit configured to select a health data value and health characteristic related to a specific disease from user's personal health data, and normalize the selected health data value and health characteristic;
a second pattern generation unit configured to generate a pattern from the normalized personal health data; and
a health data value prediction unit configured extract a result of prediction on the user's health data value by applying a prediction model to the generated pattern.

13. The apparatus of claim 8, wherein the prediction model is generated by applying of a machine learning technique that comprises deep network learning, machine learning, support vector machine (SVM), a neural network or the like.

14. The apparatus of claim 8, wherein the prediction model predicts a future health data value from past time-series personal health data, wherein the future health data value is predicted by recovering of a damaged portion of the past time-series health data.
